(19) United States
(12) Patent Application Publication
(10) Pub. No.: US 2011/0218309 A1
(43) Pub. Date: Sep. 8, 2011

(54) Preparation of ultra high molecular mass polyethylene and ultra high molecular mass polyethylene having improved crosslink ability prepared thereb

(75) Inventors: Shahram Mihan, Bad Soden (DE); Lars Koelling, Mannheim (DE); Heinz Vogt, Frankfurt (DE); Dieter Lilge, Limburgerhof (DE); Hans-Friedrich Enderle, Frankfurt (DE); Hans-Jörg Nitz, Frankfurt (DE); Lenka Lukesova, Frankfurt (DE)

(73) Assignee: BASELL POLYOLEFINE GMBH, Wesseling (DE)

(21) Appl. No.: 13/128,336

(22) PCT Filed: Nov. 18, 2009
(86) PCT No.: PCT/EP09/08183

§ 371 Date: May 9, 2011

Related U.S. Application Data
(60) Provisional application No. 61/276,980, filed on Sep. 18, 2009.

(30) Foreign Application Priority Data
Nov. 27, 2008 (EP) 08020615.4

(51) Int. Cl. C08F 4/22; C08F 4/76; C08F 10/02

(52) U.S. Cl. 526/130

(57) ABSTRACT

The invention pertains to a method for the preparation of ultra high molecular mass polyethylene by polymerization in suspension or in gas phase in the presence of a chromium catalyst sitting on an alumosilicate support material. The chromium catalyst has been subjected to a fluorinating treatment and the polymerization is performed under low temperature conditions within a temperature range of from 50 to 100° C. The invention pertains also to ultra high molecular mass polyethylene prepared by that method and having a density in the range of from 0.930 to 0.950 g/cm³.

This application is the U.S. national phase of International Application PCT/EP2009/008183, filed Nov. 18, 2009, claiming priority to European Application 08020615.4 filed Nov. 27, 2008 and the benefit under 35 U.S.C. 119(e) of U.S. Provisional Application No. 61/276,980, filed Sep. 18, 2009; the disclosures of International Application PCT/EP2009/008183, European Application 08020615.4 and U.S. Provisional Application No. 61/276,980, each as filed, are incorporated herein by reference.

Ultra high molecular mass polyethylene is the usual designation for a group of linear polymers containing predominantly ethylene units in which the polymers have a molecular weight of about 1 to 1.5·10⁶ g/mol or even higher. Such polymers are well known in the art for their high impact strength, their high abrasion resistance and for general properties making them superior useful for such applications, for which lower molecular mass polyethylene is less suitable due to its poor mechanical properties. Especially, the ultra high molecular mass polyethylene is available for making gears, bearings, guide rails, and slider beds in conveyors and other similar articles.

Ultra high molecular mass polyethylene is described in U.S. Pat. No. 3,882,096. Such prior art reference describes a mixed chromium/titanium catalyst and the preparation of the polymer in its presence under costumary polymerization conditions. The polymers described by the reference have a molecular mass of up to 3·10⁶ g/mol.

WO98/20054 describes a gas phase fluidized bed polymerization process and the preparation of ultra high molecular weight polyethylene in the presence of a chromocene catalyst sitting on a thermally activated silica support material. The polyethylene prepared along that polymerization have a density in the range of from 0.929 to 0.936 g/cm³ and a mean particle size of from 0.7 to 1 mm.

Several other publications such as EP-A-0 645 403 describe ultra high molecular mass polyethylene prepared in the presence of Ziegler catalyst. The polymer prepared thereby has a mean particle size of about 200 μm or less and a bulk density of from 350 to 460 g/l.

Up to now, it was a serious technical problem to prepare ultra high molecular mass polyethylene having high density of up to 0.945 g/cm³ or even higher and in combination therewith a mean particle size of 0.8 mm or even higher, which have in addition thereto the ability to create crosslinks due to the presence of a sufficient number of vinyl groups.

Such technical problem is solved now surprisingly by the preparation of ultra high molecular mass polyethylene by polymerization in suspension or in gas phase in the presence of a chromium catalyst sitting on an alumosilicate support material, which chromium catalyst has been subjected to a fluorinating treatment and which polymerization is performed under low temperature conditions within a temperature range of from 50 to 100° C.

Surprisingly, it has now been found that by suspension polymerization in the presence of a fluorine-modified chromium catalyst of Phillips type, it becomes possible to prepare ultra high molecular mass polyethylene whose property profile in terms of density, mean particle size and ability to create crosslinks is ideally suitable to solve the technical problem as outlined before. It has been found that using the fluorine-modified chromium catalyst, it becomes possible to prepare ultra high molecular mass polyethylene having better crosslink ability due to a multitude of vinyl end groups created by the catalyst during polymerization.

In addition, another important improvement is to see in a low fine particles content of the polyethylene prepared of less than 100 μm. The polymer has additionally a low chlorine content of less than 1 ppm and, thus, any stearate additives are not necessary for its stabilization. The polymer prepared according to the invention has a higher impact resistance and a higher stiffness/impact resistance balance.

By the instant invention an easier powder handling is possible due to the larger mean particle size of 800 μm versus a mean particle size in the range of from 100 to about 200 μm of an ultra high molecular mass polyethylene prepared in the presence of Ziegler catalyst. A better further processability results from a broader molecular weight distribution and higher stiffness, if compared with products resulting from polymerisation in the presence of Ziegler catalyst, such products having lower density somehow.

This is particularly surprising since the relationship between these properties is usually the opposite, i.e. further processability goes down, if stiffness and density goes up. These unusual properties of the ultra high molecular mass polyethylene prepared in the presence of the fluorine-modified chromium catalyst can be used particularly advantageously in producing gears, bearings, guide rails, and slider beds in conveyors and other similar articles.

The ultra high molecular mass polyethylene materials prepared according to the invention are homo- or copolymers of ethylene and of other comonomers being 1-alkenes, such as propene, butene, hexene, octene, or the like in an amount of up to 5 weight-%, based on the total weight of the copolymer. Particular preference is given to high-density homopolymers of ethylene (HDPE), and also to high-density ethylene copolymers using butene and/or hexene as comonomers.

The ultra high molecular mass polyethylene of the invention are prepared using a fluorine-modified chromium catalyst. To this end, known prior-art catalysts are fluorine-modified or subjected to a fluorinating treatment by way of suitable fluorinating agents. Conventional chromium-containing polymerization catalysts which comprise silica gel or modified silica gel as support material and chromium as catalytically active component have long been known in the prior art as Phillips catalysts in the preparation of high-density polyethylene. Phillips catalysts are generally activated at high temperatures before the polymerization in order to stabilize chromium in the form of a chromium(VI) species on the catalyst surface. This species is reduced by adding ethylene or reducing agents in order to develop the catalytically active chromium species.

Particularly suitable catalysts in the sense of the instant invention are air-activated chromium catalysts sitting on an alumosilicate support material which are modified using suitable inorganic fluorinating agents. Spherical support materials based on alumosilicate with a relatively high Al-content of from 20 to 40% (calculated as weight percent) are particularly suitable. These support materials are then loaded with suitable chromium compounds and thereafter thermally activated in a stream of anhydrous oxygen at temperatures of from 400 to 600° C.

The preparation of suitable catalysts is typically described in DE 25 40 279, by way of example, and the fluoride doping which is needed for the fluorinating treatment here may, if desired, take place during the preparation of catalyst precursors, i.e. during the impregnation step, or in the activator during the activation step, for example by coimpregnation of the support with a solution of the fluorinating agent and the desired chromium compound, or by adding fluorinating agents within the gas stream during thermal air-activation.

Suitable fluorinating agents for doping supported chromium catalysts are any of the following fluorinating agents, such as ClF₃, BrF₃, BrF₅, ammonium hexafluorosilicate ((NH₄)₂SiF₆), ammonium tetrafluoroborate (NH₄BF₄), ammonium hexafluoroaluminate ((NH₄)₃AlF₆), NH₄HF₂, ammonium hexafluoroplatinate (NH₄PtF₆), ammonium hexafluorotitanate ((NH₄)₂TiF₆), ammonium hexafluorozirconate ((NH₄)₂ZrF₆), and the like. Particular preference is given to supported chromium catalysts doped with ammonium hexafluorosilicate.

The polymerization processes used are these of the prior art with fluorine-modified chromium catalysts to prepare polyolefins which can be used according to the invention, examples of these processes being suspension polymerization in stirred vessel or loop reactor or else dry-phase polymerization, gas-phase polymerization with agitation, gas phase polymerization in a fluidized bed, whereby suspension polymerization is preferred. These processes may be carried out either in single-reactor systems or else in reactor-cascade systems.

The minimum mean particle size of the ultra high molecular mass polyethylene homo- or copolymers prepared according to the invention using fluorine-doped chromium catalysts sitting on alomosilicate support material is 300 μm, preferably 600 μm, whereas its density lies in the range from 0.930 to 0.950 g/cm³, preferably from 0.938 to 0.945 g/cm³.

An essential component of the chromium catalyst used for the preparation of the ultra high molecular mass polyethylene according to the instant invention is the alumosilicate support material. Such alumosilicate support material comprises a high content of aluminum oxide within the range of from 40 to 80 weight-%, calculated on the total weight of the alumosilicate material. Preferably from 50 to 70 weight-%. Such high content of aluminum oxide supports the catalytic activity of the flourine-modified chromium catalyst advantageously.

The alumosilicate material suitable for the instant invention is preferably a finely sized porous material having a specific surface of from 200 to 700 m²/g. The mean particle diameter of the finely sized support material ranges from 5 to 300 μm. preferably from 5 to 150 μm. The alumosilicate support material suitable for the instant invention is commercially availble and its preparation and properties are described par example in DE-A 32 44 032.

Another advantage during the preparation of the ultra high molecular mass polyethylene may result from the additional presence of zirconium as constituent of a modification within the chromium catalyst. An important aspect of the catalyst of this embodiment is therefore that the chromium content is from 0.01 to 5% by weight, preferably from 0.1 to 2% by weight, particularly preferably from 0.2 to 1% by weight, and the zirconium content is from 0.01 to 10% by weight, preferably from 0.1 to 7% by weight, particularly preferably from 0.5 to 3% by weight. The chromium and zirconium contents are in this case the ratio of the mass of the respective element to the total mass of the finished catalyst comprising also the alumosilicate support material.

The zirconium is preferably deposited on the surface of the support material, whereby the term “surface” in this context referring both to the external surface and also, in particular, the internal surface in the pores of the alumosilicate support material. In a further embodiment of the present invention, the zirconium can also be incorporated into the matrix of the support material as constituent of the alumosilicate support material. If the zirconium is deposited on the surface of the support material, it is supplied thereto as a solution or a suspension of a zirconium compound, preferably of an inorganic zirconium compound.

The invention will be described in more detail referring on the following working examples, whereby the scope of the invention by no means is limited to the exemplified particulars.

### EXAMPLE 1.1 AND 1.2

### Preparation of Catalyst Comprising Cr

A biconical dryer was charged with 1.5 kg of a commercially available alumosilicate ®Siral 40 HPV (Sasol) having a content of aluminum oxide of 59 weight-%, a pore volume of 1.05 ml/g, measured according to W. B. Innes, Analytical Chemistry, Vol. 28, page 332, (1956), and a specific surface of 503 m²/g, measured according to the BET-method published in Journal of the American Chemical Society, Vol. 60, pages 309 ff, (1938), and a mean particle size of 93 μm, measured by Beckmann Counter, was combined with 1.4 l of a solution of 137 g Cr(NO₃)₃.9H₂O in methanol within the dryer and mixed therein over a time period of 60 min.

The chromium containing alumosilicate material was then dried over a time period of 5 h at 90° C. in vacuo and thereafter covered with nitrogen. 150 g of the thus dried material was mixed with ammonium hexafluorosilicate (ASF) in the amounts as described in the following table 1 and thereafter the thermal activation took place at temperatures also exemplified in table 1 over a time period of 2 h in a fluidized bed quartz activator. Thereafter it was cooled down in the presence of dry nitrogen.

The resulting chromium containing and fluorinated catalyst had a chromium content of 1.2 weight-%, resulting from elementary analysis. Such catalyst was directly employed for the polymerization in the respective polymerization examples described below.

### EXAMPLE 1.3

### Preparation of Catalyst Comprising Cr and Zr

A biconical dryer was charged with 1.5 kg of the same support material Siral® 40 HPV like example 1.1. Subsequently a solution of 137 g Cr(NO₃)₃.9H₂O in 1.4 l n-propanol was added. Then 107.7 g Zr(IV) propylate (70% solution in n-propanol) was added. The solution was transferred slowly to the biconical dryer and the system was purged with 0.2 l of n-propanol. The suspension was mixed for 1 h and subsequently dried at 120° C. jacket temperature for a time period of 8 h in vacuo and thereafter covered with dry nitrogen.

The residual steps were the same as in example 1. The resulting chromium and zirconium containing and fluorinated catalyst had a chromium content of 1.2 weight-% and a zirconium content of 2 weight-%, both resulting from elementary analysis.

TABLE 1

| Example No. | ASF [weight-%]¹⁾ | Activation temp. [° C.] |
|---|---|---|
| 1.1 | 6 | 510 |
| 1.2 | 5 | 550 |
| 1.3 | 4 | 510 |

¹⁾weight-% is claculated on the basis of 150 g of dried support material plus metal compound (Cr or Cr plus Zr).

### EXAMPLES 2.1 TO 2.5

### Polymerization

The polymerization was performed within a stainless steel autoclave reactor comprising a total volume of 10 l under a pressure of 40 bar (=4 MPa). The reactor was filled with 4 l of iso-butane. The reactor has had a temperature as indicated in table 2 below. By the addition of 480 mg of catalyst according to one of examples 1.1 to 1.3 respectively to the reactor polymer was produced over a time period for polymerization as given for each example in the same table 2, under different productivities. The polymerization conditions and the properties of the resulting polymer are illustrated in the following tables 2 and 3 below.

TABLE 2
(polymerization conditions)

| | | Temperature | Productivity | polymerization |
|---|---|---|---|---|
| Example | Catalyst of | [° C.] | [g/g] | time [h] |
| 2.1 | Example 1.1 | 70 | 3300 | 2 |
| 2.2 | Example 1.1 | 80 | 4200 | 2 |
| 2.3 | Example 1.3 | 70 | 2000 | 2 |
| | (modified by | | | |
| | 2 wt-% of Zr) | | | |
| 2.4 | Example 1.2 | 80 | 4500 | 2 |
| 2.5 | Example 1.1 | 75 | 2500 | 2 |
| 2.6 | Example 1.1 | 80 | 2100 | 1 |

### Measurement Methods

Intrinsic viscosity (i.V.) is measured on the basis of ISO 1628. A net weight of 20 mg PE at a volume of 361.2 ml gives a concentration von 0.05 mg/ml. The mixture is slewed periodically (every 10 to 20 minutes) at about 160° C. to dissolve the polymer. Subsequently measurement is carried out according to the standard procedure.

Charpy is measured according to the double notched method pursuant to EN-ISO 11542-2:1998.

Density is measured according to the floatation method.

Vinyl groups are measured by IR spectroscopy at wave number of 907 cm⁻¹. The values have been calibrated by comparison with reference samples determined by means of high sensitive C¹³-NMR spectroskopy. In addition, a correction was made taking into account the thickness of the samples. The method is described in Macromol. Chem., Macromol. Symp. 5, 105-133 (1986) in detail.

Methyl groups are measured by IR spectr. at wave number of 1378 cm⁻¹ according to ASTM D 6248-98.

TABLE 3
(polymer properties)

| | | intr. | den- | | av. | vinyl | methyl |
|---|---|---|---|---|---|---|---|
| | | Visc. | sity | charpy | part. | groups | groups |
| | ash | [cm³/ | [g/ | [kJ/ | size | [1/1000 | [1/1000 |
| Ex. | [ppm] | g] | cm³] | m²] | [μm] | C-at.] | C-at.] |
| 2.1 | 300 | | 0.941 | | 1395 | 0.36 | <1 |
| 2.2 | 240 | 22.2 | 0.942 | | 1442 | 0.42 | <1 |
| 2.3 | 500 | | 0.942 | 186 | | 0.47 | <1 |
| 2.4 | 220 | | 0.942 | | | 0.46 | <1 |
| 2.5 | 400 | 20.5 | 0.942 | 210 | 1463 | 0.45 | <1 |
| 2.6 | 480 | | 0.945 | | 796 | 0.50 | |

### EXAMPLE 3

### Comparison

For the purpose of comparison, a commercially available ultra high molecular mass polyethylene ®GUR 4142 of Ticona GmbH, Germany, was tested in the same manner as the polymers produced according to examples 2.1 through 2.5 above. The result appears in the following table 4:

TABLE 4

| Ex- | | i.V. | density | charpy | av. part. | vinyl groups |
|---|---|---|---|---|---|---|
| am- | ash | [cm³/ | [g/ | [kJ/ | size | [1/1000 |
| ple | [ppm] | g] | cm³] | m²] | [μm] | C-at.] |
| 3 | 140 | 19.1 | 0.929 | 192 | 190 | 0.02 |

By means of the working examples, it becomes apparent that the density of the polymer according to the invention is much higher than the density of the comparison material GUR prepared in the presence of a Ziegler catalyst and that the polymer according to the invention has a much bigger particle size and comprises more vinyl groups.

1. A method for the preparation of ultra high molecular mass polyethylene comprising polymerizing in suspension or in gas phase, in the presence of a chromium catalyst sitting on an alumosilicate support material, wherein the chromium catalyst has been subjected to a fluorinating treatment and the polymerization is performed within a temperature range of from 50 to 100° C.

2. The method according to claim 1, wherein the ultra high molecular mass polyethylene prepared is a homo- or copolymer of ethylene and of other comonomers selected from propene, butene, hexene, octene or mixtures thereof in an amount of up to 5 weight-%, based on the total weight of the copolymer.

3. The method according to claim 1, wherein the chromium catalyst is sitting on a spherical support material of alumosilicate with an Al-content of from 20 to 40%, calculated as weight percent and wherein the chromium catalyst and the support material are thermally activated in a stream of anhydrous oxygen at temperatures of from 400 to 600° C.

4. The method according to claim 1, wherein the fluorinating treatment is performed by fluorinating agents for doping supported chromium catalysts selected from ClF₃, BrF₃, BrF₅, ammonium hexafluorosilicate ((NH₄)₂SiF₆), ammonium tetrafluoroborate (NH₄BF₄), ammonium hexafluoroaluminate ((NH₄)₃AlF₆), NH₄HF₂, ammonium hexafluoroplatinate (NH₄PtF₆), ammonium hexafluorotitanate ((NH₄)₂TiF₆), or ammonium hexafluorozirconate ((NH₄)₂ZrF₆).

5. The method according to claim 1, wherein the alumosilicate support material comprises a content of aluminum oxide within the range of from 40 to 80 weight-%, calculated on the total weight of the alumosilicate material.

6. The method according to claim 1, wherein the alumosilicate material is a finely sized porous material having a specific surface of from 200 to 700 m²/g and a mean particle diameter within the range of from 5 to 300 μm.

7. The method according to claim 1, wherein the chromium catalyst further comprises zirconium as a constituent of a modification and wherein the chromium content is from 0.01 to 5% by weight, and the zirconium content is from 0.01 to 10% by weight, calculated as the mass of the respective element to the total mass of the finished catalyst comprising also the alumosilicate support material.

8. An ultra high molecular mass polyethylene prepared according to claim 1 having a minimum mean particle size of 300 μm, and a density in the range from 0.930 to 0.950 g/cm³.

9. The ultra high molecular mass polyethylene according to claim 8, wherein the polyethylene comprises vinyl groups in an amount of at least 0.2 vinyl groups per 1000 C-atoms.

10. The method according to claim 4 wherein the fluorinating agent is ammonium hexafluorosilicate.

11. The method according to claim 5 wherein the content of aluminum oxide is 50 to 70 weight %.

12. The method according to claim 6 wherein the mean particle diameter is from 5 to 150 μm.

13. The method according to claim 7 wherein the chromium content is from 0.1 to 2% by weight.

14. The method according to claim 13 wherein the chromium content is from 0.2 to 1% by weight.

15. The method according to claim 7 wherein zirconium content is from 0.1 to 7% by weight.

16. The method according to claim 15 wherein the zirconium is from 0.5 to 3% by weight.

17. The method according to claim 8, wherein the minimum mean particle size is 600 μm.

18. The method according to claim 8 wherein the density is in the range from 0.938 to 0.945 g/cm³.
